(19) United States
(12) Patent Application Publication
(10) Pub. No.: US 2015/0208844 A1
(43) Pub. Date: Jul. 30, 2015

(54) FOOD PROCESSOR

(71) Applicant: Ken Liang, New Taipei City (TW)

(72) Inventor: Ken Liang, New Taipei City (TW)

(21) Appl. No.: 14/165,394

(22) Filed: Jan. 27, 2014

(51) Int. Cl. A47J 19/02; A47J 43/06; A47J 43/046

(52) U.S. Cl. CPC A47J 19/027; A47J 43/046; A47J 43/06

(57) ABSTRACT

The food processor includes a stainless steel cup, a plastic base and a flexible ring. The cup has an opening, a bottom and a cup body. The bottom is formed with a through hole for receiving a knife. The plastic base has a recess for receiving the bottom of the cup. A bottom surface of the recess is formed with installation holes and an insertion hole corresponding to the through hole. The flexible ring is sandwiched between the cup body and the plastic base. A top edge of the flexible ring is outward formed with a sealing flange for covering a gap between the cup body and the plastic base.

### BACKGROUND OF THE INVENTION

1. Technical Field

The invention relates to cup structures, particularly to cups used in food processors.

2. Relate

A food processor is a kitchen appliance used to facilitate repetitive tasks in the preparation of food. Food processors are similar to blenders in many ways. The primary difference is that food processors use interchangeable blades and disks (attachments) instead of a fixed blade. Usually, little or no liquid is required in the operation of the food processor, unlike a blender, which requires some amount of liquid to move the particles around the blade.

A conventional food processor usually uses a plastic cup (bowl) which is suitable for normal or low temperature. Poisonous material will be released when such a plastic cup meets high temperature food. Thus a plastic cup is not safe enough.

Additionally, to purify juice from a food processor, a filter cup may be put in the cup. However, the manner of fixing the filter cup is difficult.

### SUMMARY OF THE INVENTION

An object of the invention is to provide a food processor, which uses a stainless steel cup to enhance food safety.

Another object of the invention is to provide a food processor, which uses a flexible ring to seal a gap and to absorb vibration.

To accomplish the above objections, the food processor of the invention includes a stainless steel cup, a plastic base and a flexible ring. The cup has an opening, a bottom and a cup body. The bottom is formed with a through hole for receiving a knife. The plastic base has a recess for receiving the bottom of the cup. A bottom surface of the recess is formed with installation holes and an insertion hole corresponding to the through hole. The flexible ring is sandwiched between the cup body and the plastic base. A top edge of the flexible ring is outward formed with a sealing flange for covering a gap between the cup body and the plastic base.

### BRIEF DESCRIPTION OF THE DRAWINGS

FIG. 1 is an exploded view of the invention;

FIG. 2 is another exploded view of the invention; and

FIG. 3 is a cross-sectional view of the invention.

### DETAILED DESCRIPTION OF THE INVENTION

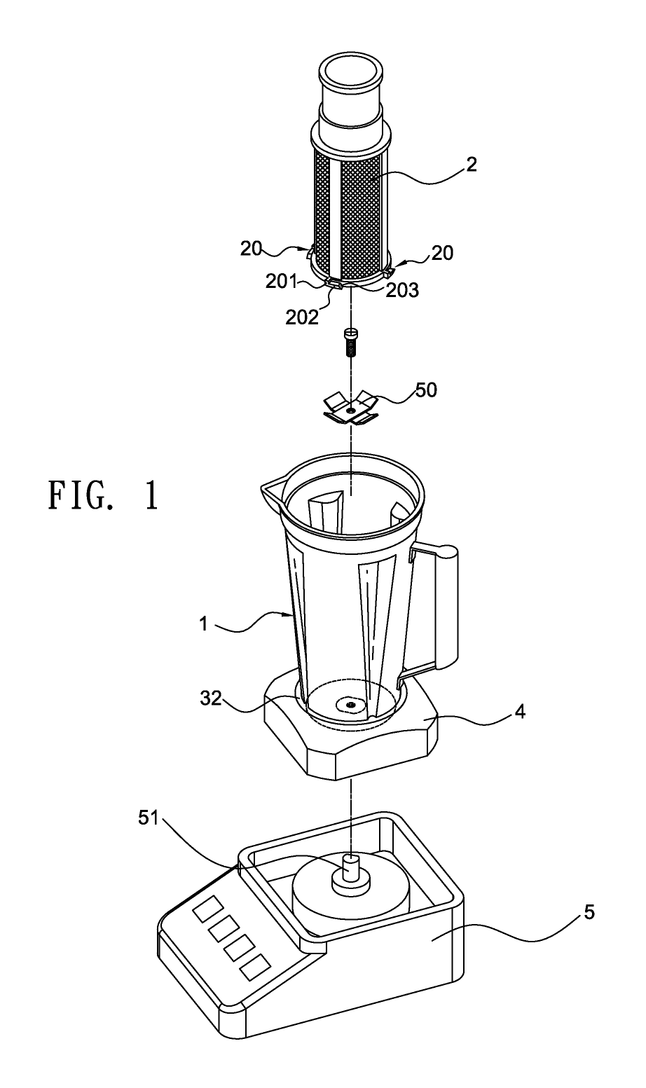

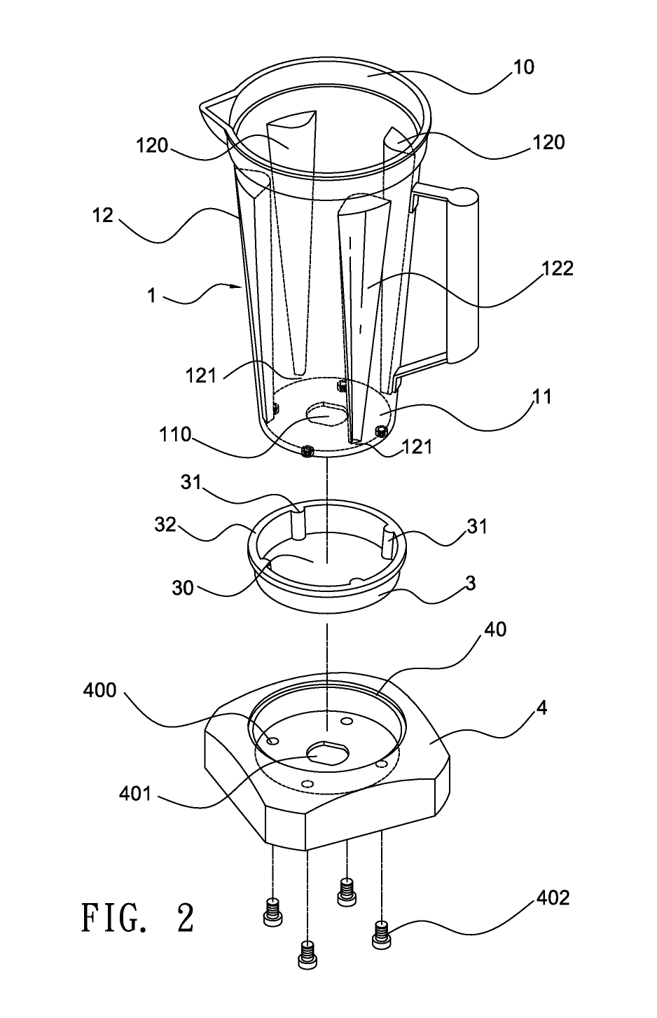

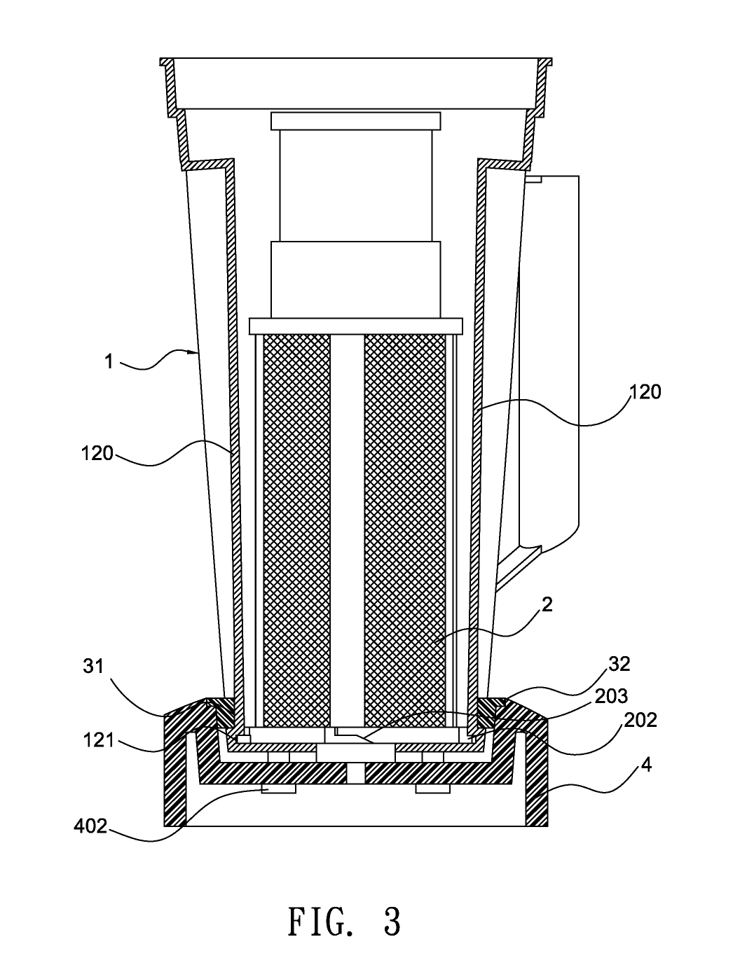

Please refer to FIGS. 1-3. The food processor of the invention includes a stainless steel cup 1, a filter cup 2, a plastic base 4 and a flexible ring 3. The filter cup 2 is fixed in the stainless steel cup 1. The flexible ring is sandwiched between the stainless steel cup 1 and the plastic base 4.

The stainless steel cup 1 has an opening 10, a bottom 11 and a cup body 12. The inside of the cup body 12 is formed with longitudinal spoiler bars 120 which can refine the food when it is rotated in the stainless steel cup 1. The outside of the cup body 12 is formed troughs 122 corresponding to the spoiler bars 120. A gap 121 is kept between the bottom end of the spoiler bar 120 and the bottom 11 of the stainless steel cup 1. The bottom 11 is formed with a through hole 110 for receiving a knife 50.

The filter cup 2 is made of stainless steel material and is formed with L-shaped protrusions 20 on the bottom thereof. The L-shaped protrusion 20 is composed of a vertical portion 201 and a horizontal portion 202 with a slant 203.

The plastic base 4 is used to connect the stainless steel cup 1 on the seat 5. The plastic base 4 has a recess 40 for receiving the bottom 11 of the stainless steel cup 1. A bottom surface of the recess 40 is formed with installation holes 400 and an insertion hole 401 corresponding to the through hole 110. The installation holes 400 are separately passed by fasteners 402 to fix the stainless steel cup 1 on the plastic base 4. The insertion hole 401 is passed by a spindle 51 of a motor in the seat 5 to connect the knife 50.

The flexible ring 3 has a hollow 30 ringed round on the cup body 12 and is sandwiched between the cup body 12 and the plastic base 4. The flexile ring 3 is made of rubber and has effects of gap sealing and vibration absorbing so as to prevent the cup body 12 and the plastic base 4 from colliding and making a noise. The inside wall of the flexible ring 3 is formed with flexible bars 31 corresponding to the troughs 122 so that the flexible bars 31 are separately embedded in the troughs 122. This can prevent the flexible ring 3 from rotating against the cup body 12. Additionally, a top edge of the flexible ring 3 is outward formed with a sealing flange 32 for covering a gap between the cup body 12 and the plastic base 4.

When assembling, the flexible ring 3 is made sandwiched between the cup body 12 and the plastic base 4 first, and then the stainless steel cup 1 is fastened to the plastic base 4 by fasteners 402. Next, the assembly of the stainless steel cup 1 and the plastic base 4 is put on the seat 5, and the spindle 51 passes though the insertion hole 401 and through hole 110 and then connects the knife 50. Finally, the filter cup 2 is fixed in the stainless steel cup 1 by engaging the L-shaped protrusions 20 with the gap 121 between the bottom end of the spoiler bar 120 and the bottom 11 of the stainless steel cup 1. In detail, the slant 203 can help the engagement of the horizontal portions 202 and spoiler bars 120.

In the present invention, the stainless steel cup 1 and the filter cup 2 are made of stainless steel, so their structural strength is much more than plastic ones. And the stainless steel material can tolerate high temperature without releasing poisonous materials. Furthermore, the flexible ring 3 sandwiched between the cup body 12 and the plastic base 4 has a great effect of gap sealing and vibration absorbing.

It will be appreciated by persons skilled in the art that the above embodiment has been described by way of example only and not in any limitative sense, and that various alterations and modifications are possible without departure from the scope of the invention as defined by the appended claims.

What is claimed is:

1. A food processor comprising:
a stainless steel cup, having an opening, a bottom and a cup body, wherein the bottom is formed with a through hole for receiving a knife;
a plastic base, having a recess for receiving the bottom of the stainless steel cup, wherein a bottom surface of the recess is formed with installation holes and an insertion hole corresponding to the through hole, the installation holes are separately passed by fasteners to fix the stainless steel cup on the plastic base, and the insertion hole is passed by a spindle of a motor; and
a flexible ring, sandwiched between the cup body and the plastic base, wherein a top edge of the flexible ring is outward formed with a sealing flange for covering a gap between the cup body and the plastic base.

2. The food processor of claim 1, wherein an inside of the cup body is formed with longitudinal spoiler bars.

3. The food processor of claim 2, wherein a gap is kept between the bottom end of the spoiler bar and the bottom of the stainless steel cup.

4. The food processor of claim 3, further comprising a filter cup in the stainless steel cup, wherein the filter cup is formed with L-shaped protrusions on a bottom thereof, each of the L-shaped protrusions is composed of a vertical portion and a horizontal portion with a slant, so that the filter cup is fixed in the stainless steel cup by engaging the L-shaped protrusions with the gap between the bottom end of the spoiler bar and the bottom of the stainless steel cup.

5. The food processor of claim 2, wherein an inside wall of the flexible ring is formed with flexible bars corresponding to troughs formed by the spoiler bars so that the flexible bars are separately embedded in the troughs.
